(19) United States
(12) Patent Application Publication
(10) Pub. No.: US 2022/0183215 A1
(43) Pub. Date: Jun. 16, 2022

(54) METHODS OF OPERATING TILLAGE IMPLEMENTS

(71) Applicant: AGCO Corporation, Duluth, GA (US)

(72) Inventors: Keith Robert CORPSTEIN, Beloit, KS (US); Jarret Lee BRINKER, Beloit, KS (US)

(21) Appl. No.: 17/594,350

(22) PCT Filed: Mar. 17, 2020
(86) PCT No.: PCT/IB2020/052419

§ 371 Date: Oct. 12, 2021

Related U.S. Application Data
(60) Provisional application No. 62/859,407, filed on Jun. 10, 2019.

(51) Int. Cl. A01B 79/00; A01B 63/00; A01B 29/04

(52) U.S. Cl. CPC A01B 79/005; A01B 29/04; A01B 63/008

(57) ABSTRACT

A method of operating a tillage implement includes providing a map of a field, defining a plurality of boundaries in the map, propelling the tillage implement through the field, and adjusting at least one operating parameter of the tillage implement when the tillage implement crosses a boundary of the plurality. A non-transitory computer-readable storage medium may include instructions that when executed by a computer, cause the computer to propel a tillage implement through a field and adjust at least one operating parameter of the tillage implement when the tillage implement crosses a boundary defined in a map.

### CROSS-REFERENCE TO RELATED APPLICATION

This application claims the benefit of the filing date of U.S. Provisional Patent Application 62/859,407, “Methods of Operating Tillage Implements,” filed Jun. 10, 2019, the entire disclosure of which is incorporated herein by reference.

### FIELD

Embodiments of the present disclosure relate to working agricultural fields. More particularly, embodiments of the present disclosure relate to methods for adjusting tillage implements based on maps.

### BACKGROUND

Crop yields are affected by a variety of factors, such as seed placement, soil quality, weather, irrigation, and nutrient applications. Soil compaction affects how seeds are placed, as well as how water and fertilizer permeates the soil. Typically, a field includes a layer of soil below the surface that is harder and denser than soil above or below it. This layer is referred to in the art as a “compaction layer.” The compaction layer is generally less permeable to air and water than the surrounding soil. Roots forming from seeds planted above the compaction layer may grow downward toward the compaction layer, and may then tend to grow outward if they cannot break through the compaction layer. The depth of the compaction layer typically varies throughout a field.

In some fields and with some crops, it is desirable to till through the compaction layer before planting to enable crops roots to grow deeper and more uniformly. However, tilling deeper requires increased fuel usage and exposes more soil to moisture loss. Furthermore, over-tilling of soil, particularly if the soil is prone to erosion, can cause erosion of the soil. Methods of measuring soil compaction are described in U.S. Pat. No. 6,834,550, “Soil Profile Force Measurement Using an Instrumented Tine,” issued Dec. 28, 2004, the entire disclosure of which is hereby incorporated herein by reference.

### BRIEF SUMMARY

In some embodiments, a method of operating a tillage implement includes providing a map of a field, defining a plurality of boundaries in the map, propelling the tillage implement through the field, and adjusting at least one operating parameter of the tillage implement when the tillage implement crosses a boundary of the plurality.

A non-transitory computer-readable storage medium may include instructions that when executed by a computer, cause the computer to propel a tillage implement through a field and adjust at least one operating parameter of the tillage implement when the tillage implement crosses a boundary defined in a map.

### BRIEF DESCRIPTION OF THE DRAWINGS

While the specification concludes with claims particularly pointing out and distinctly claiming what are regarded as embodiments of the present disclosure, various features and advantages of embodiments of the disclosure may be more readily ascertained from the following description of example embodiments of the disclosure when read in conjunction with the accompanying drawings, in which:

FIG. 1 is a simplified top view of a tractor pulling a tillage implement that may be operated as disclosed herein;

FIG. 2 illustrates a map 200 that may be used in the methods disclosed;

FIG. 3 is a simplified flowchart illustrating a method of operating tillage implements; and

FIG. 4 illustrates an example computer-readable storage medium comprising processor-executable instructions configured to embody one or more of the methods of operating tillage implements, such as the method illustrated in FIG. 3.

### DETAILED DESCRIPTION

The illustrations presented herein are not actual views of any tillage implement or portion thereof, but are merely idealized representations that are employed to describe example embodiments of the present disclosure. Additionally, elements common between figures may retain the same numerical designation.

The following description provides specific details of embodiments of the present disclosure in order to provide a thorough description thereof. However, a person of ordinary skill in the art will understand that the embodiments of the disclosure may be practiced without employing many such specific details. Indeed, the embodiments of the disclosure may be practiced in conjunction with conventional techniques employed in the industry. In addition, the description provided below does not include all elements to form a complete structure or assembly. Only those process acts and structures necessary to understand the embodiments of the disclosure are described in detail below. Additional conventional acts and structures may be used. Also note, the drawings accompanying the application are for illustrative purposes only, and are thus not drawn to scale.

As used herein, the terms “comprising,” “including,” “containing,” “characterized by,” and grammatical equivalents thereof are inclusive or open-ended terms that do not exclude additional, unrecited elements or method steps, but also include the more restrictive terms “consisting of” and “consisting essentially of” and grammatical equivalents thereof.

As used herein, the term “may” with respect to a material, structure, feature, or method act indicates that such is contemplated for use in implementation of an embodiment of the disclosure, and such term is used in preference to the more restrictive term “is” so as to avoid any implication that other, compatible materials, structures, features, and methods usable in combination therewith should or must be excluded.

As used herein, the term “configured” refers to a size, shape, material composition, and arrangement of one or more of at least one structure and at least one apparatus facilitating operation of one or more of the structure and the apparatus in a predetermined way.

As used herein, the singular forms following “a,” “an,” and “the” are intended to include the plural forms as well, unless the context clearly indicates otherwise.

As used herein, the term “and/or” includes any and all combinations of one or more of the associated listed items.

As used herein, spatially relative terms, such as “beneath,” “below,” “lower,” “bottom,” “above,” “upper,” “top,” “front,” “rear,” “left,” “right,” and the like, may be used for ease of description to describe one element's or feature's relationship to another element(s) or feature(s) as illustrated in the figures. Unless otherwise specified, the spatially relative terms are intended to encompass different orientations of the materials in addition to the orientation depicted in the figures.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” used in reference to a given parameter is inclusive of the stated value and has the meaning dictated by the context (e.g., it includes the degree of error associated with measurement of the given parameter).

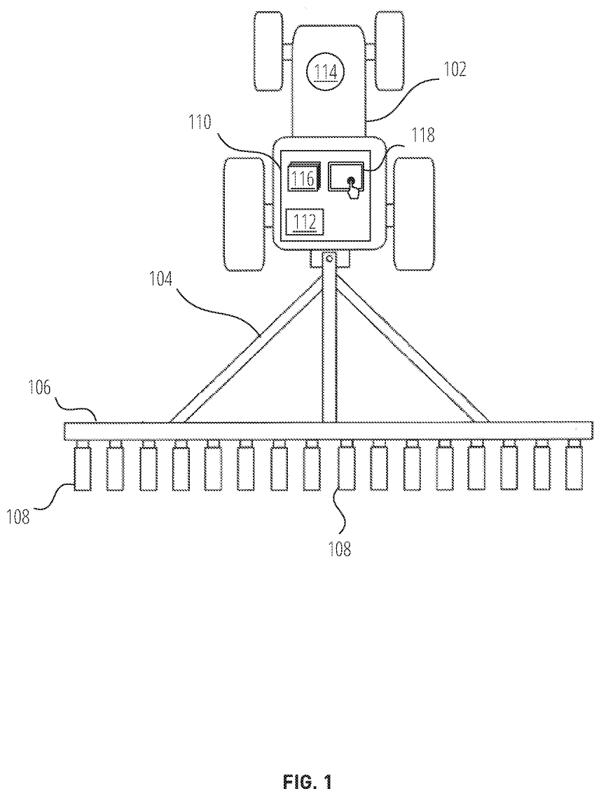

FIG. 1 is a simplified top view illustrating a tractor 102 drawing a tillage implement 104, which includes a frame 106 supporting multiple tilling tools 108. A computer 110, which may include a processor 112, memory, and graphical user interface (“GUI”) 118 (e.g., a touch-screen interface), is typically located in the cab of the tractor 102. A global positioning system (“GPS”) receiver 114 may be mounted to the tractor 102 and connected to communicate with the processor 112. The processor 112 may be configured to communicate with the tilling tools 108. The processor 112 may communicate by wired or wireless communication.

The processor 112 may be configured to adjust operating parameters of the tillage implement 104, store and retrieve information in a data storage device 116, and/or display information on the graphical user interface 118 (depicted as a touch-screen, though other types of interface may also be used). The processor 112 may typically adjust the operating parameters of the tillage implement 104 based on known variations of the properties of the field or based on information collected while working the field. For example, the data storage device 116 may store one or more maps containing information about the field, and the processor 112 may adjust the tillage implement 104 based on the position in the field and information from the map(s). The maps may include, for example, topographic or soil-quality maps.

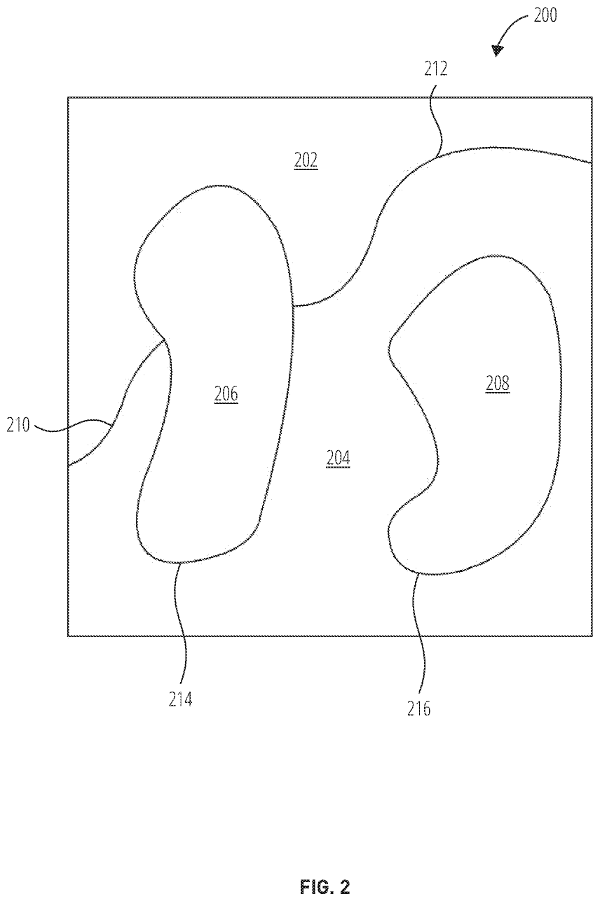

FIG. 2 is a simplified representation of a map 200 of a field. The map 200 may include different areas 202-208 separated by boundaries 210-216. The areas 202-208 may have different soil characteristics, and the boundaries 210-216 may correspond to changes in the soil characteristics of a preselected magnitude. For example, if the map 200 represents the amount of residue over the soil (i.e., plant material that is not mixed into the soil), then the boundaries 210-216 may divide values of residue into different bins, categories, or ranges (e.g., low, medium, and high; specific numerical values; or any other selected classifications). In the map 200, for example, the areas 202 may have low residue, the area 204 may have medium residue, and the areas 206 and 208 may each have high residue. Thus, it may be beneficial to work the areas 202-208 differently. Furthermore, the areas 202-208 may have different soil compositions, such as the amount of organic material, the amount of sand, the amount of clay, etc. The map 200 may include any number of areas 202-208 with any selected properties.

The map 200 may include, in addition to or instead of soil characteristics, topographical information. For example, the boundaries 210 and 212 may divide a lower area 202 from a higher area 204, whereas the boundaries 214 and 216 may separate certain areas 206 and 208 of soil having a high tendency to erode. Thus, it may be beneficial to till the area 202 differently than the areas 204-208.

Generation of maps of fields is described generally in U.S. Patent Application Publication 2002/0022929 A1, “System and Method for Creating Field Attribute Maps for Site-Specific Farming,” published Feb. 21, 2002; U.S. Pat. No. 6,606,542, “System and Method for Creating Agricultural Decision and Application Maps for Automated Agricultural Machines,” issued Aug. 12, 2003; and International Patent Publication WO 2018/080979 A1, “Land Mapping and Guidance System,” published May 3, 2018; the entire disclosures of which are hereby incorporated by reference.

Returning to FIG. 1, the computer 110 may correlate information about the field from the map 200 with a location of the tillage implement 104 as determined by the GPS receiver 114. The computer 110 may determine target values of operating parameters for the tillage implement 104 based on the properties of the soil at that particular location. If any operating parameter has a target value different from the current value of that operating parameter, the computer 110 may adjust the tillage implement 104 accordingly. This change typically occurs when the tillage implement 104 crosses the boundaries 210-216.

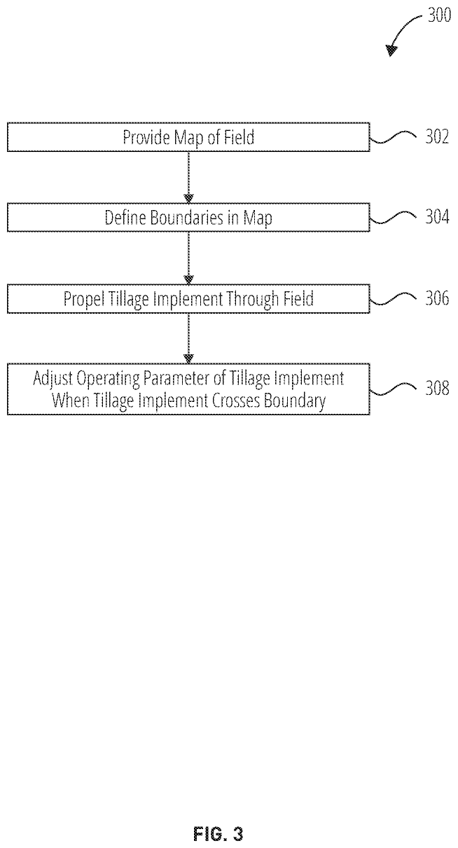

FIG. 3 is a simplified flow chart illustrating a method 300 in which the tractor 102 and the tillage implement 104 (FIG. 1) may be used to work a field.

As depicted in block 302, the method 300 includes providing a map (e.g., map 200 in FIG. 2) of a field. As discussed above, the map may be a topographic map, a soil-quality map, a residue map, etc. The map may be provided to the computer 110 (FIG. 1) by any method known in the art, such as by transmission via wired or wireless connections, and may be stored in the data storage device 116.

In block 304, the method 300 includes defining boundaries in the map. The boundaries may be defined to separate various areas of the map based on erosion propensity, elevation, or other properties. The boundaries may define different areas in which the tillage implement 104 will have different operating parameters.

In block 306, the method 300 includes propelling the tillage implement 104 through the field. The tillage implement 104 is typically pulled behind the tractor 102.

In block 308, the computer 110 adjusts an operating parameter of the tillage implement 104 (or instructs an actuator or other device to adjust an operating parameter) when the tillage implement 104 crosses a boundary. For example, the computer 110 may adjust a depth of the tillage implement 104 with respect to the surface of the field, an aggressiveness of the tillage implement 104, a rolling basket pressure of the tillage implement 104 (e.g., as described in U.S. Pat. No. 9,635,797, “Actuator Adjusted Rolling Baskets,” issued May 2, 2017, the entire disclosure of which is incorporated herein by reference) or a gang angle of the tillage implement 104 (e.g., as described in International Patent Publication WO 2018/020307 A1, “Tillage Implement Having a Mechanism for Adjusting Disc Blade Angle,” published Feb. 1, 2018, and U.S. Patent Publication 2013/0048323, “Tillage Implement with Adjustable Gang Angle,” published Sep. 17, 2013, the entire disclosures of each of which are incorporated herein by reference).

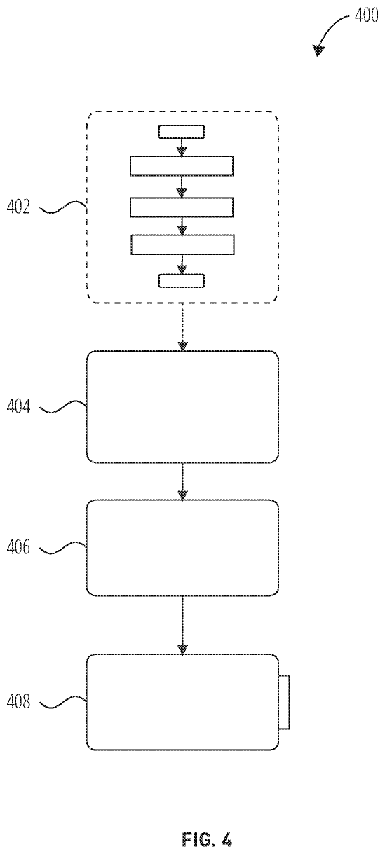

Still other embodiments involve a computer-readable storage medium (e.g., a non-transitory computer-readable storage medium) having processor-executable instructions configured to implement one or more of the techniques presented herein. An example computer-readable medium that may be devised is illustrated in FIG. 4, wherein an implementation 400 includes a computer-readable storage medium 402 (e.g., a flash drive, CD-R, DVD-R, application-specific integrated circuit (ASIC), field-programmable gate array (FPGA), a platter of a hard disk drive, etc.), on which is computer-readable data 404. This computer-readable data 404 in turn includes a set of processor-executable instructions 406 configured to operate according to one or more of the principles set forth herein. In some embodiments, the processor-executable instructions 406 may be configured to cause the computer 110 (FIG. 1) to perform operations 408 when executed via a processing unit, such as at least some of the example method 300 depicted in FIG. 3. In other embodiments, the processor-executable instructions 406 may be configured to implement a system, such as at least some of the example tractor 102 and tillage implement 104 (FIG. 1). Many such computer-readable media may be devised by those of ordinary skill in the art that are configured to operate in accordance with one or more of the techniques presented herein.

The apparatus and methods disclosed herein may benefit a farmer by tailoring tilling operations based on different field conditions. Different areas within the field may be worked differently, and therefore the methods may avoid working highly erodible soil too aggressively. Furthermore, if adjusting the tillage implement is automated in a computer, the changes can be implemented more precisely than would be possible if the tractor operator were required to make manual adjustments in the field. Therefore, the end result of the methods may be better consistency of soil conditions after tilling and lower erosion rates. This may translate into higher crop yield and better return-on-investment for the farmer.

Additional non-limiting example embodiments of the disclosure are described below.

Embodiment 1: A method of operating a tillage implement, comprising providing a map of a field, defining a plurality of boundaries in the map, propelling the tillage implement through the field, and adjusting at least one operating parameter of the tillage implement when the tillage implement crosses a boundary of the plurality.

Embodiment 2: The method of Embodiment 1, wherein providing the map comprises providing a topographic map of the field.

Embodiment 3: The method of Embodiment 1 or Embodiment 2, wherein providing the map comprises providing a soil map of the field.

Embodiment 4: The method any one of Embodiment 1 through Embodiment 3, wherein providing the map comprises providing the map to a computer carried by a tractor configured to propel the tillage implement through the field.

Embodiment 5: The method of Embodiment 4, wherein adjusting at least one operating parameter of the tillage implement comprises sending an electronic signal from the computer to the tillage implement.

Embodiment 6: The method of any one of Embodiment 1 through Embodiment 5, wherein defining the boundaries in the map comprises defining the boundaries to separate areas based on erosion propensity.

Embodiment 7: The method of any one of Embodiment 1 through Embodiment 6, wherein defining the boundaries in the map comprises defining the boundaries to separate areas based on elevation.

Embodiment 8: The method of any one of Embodiment 1 through Embodiment 7, wherein adjusting at least one operating parameter of the tillage implement comprises adjusting a depth of the tillage implement.

Embodiment 9: The method of any one of Embodiment 1 through Embodiment 8, wherein adjusting at least one operating parameter of the tillage implement comprises adjusting an aggressiveness of the tillage implement.

Embodiment 10: The method of any one of Embodiment 1 through Embodiment 9, wherein adjusting at least one operating parameter of the tillage implement comprises adjusting a rolling basket pressure of the tillage implement.

Embodiment 11: The method of any one of Embodiment 1 through Embodiment 10, wherein adjusting at least one operating parameter of the tillage implement comprises adjusting a gang angle of the tillage implement.

Embodiment 12: A non-transitory computer-readable storage medium, the computer-readable storage medium including instructions that when executed by a computer, cause the computer to propel a tillage implement through a field and adjust at least one operating parameter of the tillage implement when the tillage implement crosses a boundary defined in a map.

Embodiment 13: The non-transitory computer-readable storage medium of Embodiment 12, further comprising the map defining at least one property of the field.

Embodiment 14: The non-transitory computer-readable storage medium of Embodiment 13, further comprising boundaries based on categories of the at least one property of the field.

Embodiment 15: The non-transitory computer-readable storage medium of Embodiment 14, wherein at least some of the boundaries are based on erosion propensity.

Embodiment 16: The non-transitory computer-readable storage medium of Embodiment 14 or Embodiment 15, wherein at least some of the boundaries are based on elevation.

Embodiment 17: The non-transitory computer-readable storage medium of any one of Embodiment 12 through Embodiment 16, wherein the instructions cause the computer to adjust at least one operating parameter selected from the group consisting of a depth of the tillage implement, an aggressiveness of the tillage implement, a rolling basket pressure of the tillage implement, and a gang angle of the tillage implement.

While the present disclosure has been described herein with respect to certain illustrated embodiments, those of ordinary skill in the art will recognize and appreciate that it is not so limited. Rather, many additions, deletions, and modifications to the illustrated embodiments may be made without departing from the scope of the disclosure as hereinafter claimed, including legal equivalents thereof. In addition, features from one embodiment may be combined with features of another embodiment while still being encompassed within the scope as contemplated by the inventor. Further, embodiments of the disclosure have utility with different and various implement types and configurations.

1. A method of operating a tillage implement, comprising:
providing a map of a field;
defining a plurality of boundaries in the map, the boundaries corresponding to soil characteristics or elevations;
propelling the tillage implement through the field; and
adjusting at least one operating parameter of the tillage implement when the tillage implement crosses a boundary of the plurality.

2. The method of claim 1, wherein providing the map comprises providing a topographic map of the field.

3. The method of claim 1, wherein providing the map comprises providing a soil map of the field.

4. The method claim 1, wherein providing the map comprises providing the map to a computer carried by a tractor configured to propel the tillage implement through the field.

5. The method of claim 4, wherein adjusting at least one operating parameter of the tillage implement comprises sending an electronic signal from the computer to the tillage implement.

6. The method of claim 1, wherein defining the boundaries in the map comprises defining the boundaries to separate areas based on erosion propensity.

7. The method of claim 1, wherein defining the boundaries in the map comprises defining the boundaries to separate areas based on elevation.

8. The method of claim 1, wherein adjusting at least one operating parameter of the tillage implement comprises adjusting a depth of the tillage implement.

9. The method of claim 1, wherein adjusting at least one operating parameter of the tillage implement comprises adjusting an aggressiveness of the tillage implement.

10. The method of claim 1, wherein adjusting at least one operating parameter of the tillage implement comprises adjusting a rolling basket pressure of the tillage implement.

11. The method of claim 1, wherein adjusting at least one operating parameter of the tillage implement comprises adjusting a gang angle of the tillage implement.

12. A non-transitory computer-readable storage medium, the computer-readable storage medium including instructions that when executed by a computer associated with an agricultural vehicle, cause the agricultural vehicle to:
propel a tillage implement through a field; and
adjust at least one operating parameter of the tillage implement when the tillage implement crosses a boundary defined in a map, the boundary corresponding to a soil characteristic or an elevation.

13. (canceled)

14. The non-transitory computer-readable storage medium of claim 12, further comprising boundaries based on categories of the soil characteristic or elevation.

15. The non-transitory computer-readable storage medium of claim 14, wherein at least some of the boundaries are based on erosion propensity.

16. The non-transitory computer-readable storage medium of claim 14, wherein at least some of the boundaries are based on elevation.

17. The non-transitory computer-readable storage medium of claim 12, wherein the instructions cause the agricultural vehicle to adjust at least one operating parameter selected from the group consisting of a depth of the tillage implement, an aggressiveness of the tillage implement, a rolling basket pressure of the tillage implement, and a gang angle of the tillage implement.
